(19) United States
(12) Patent Application Publication
(10) Pub. No.: US 2026/0326090 A1
(43) Pub. Date: Oct. 22, 2026

(54) HIGH-SILICA PD-BASED SMALL PORE ZEOLITE CATALYSTS FOR LOW TEMPERATURE CH4 OXIDATION

(71) Applicants: Syracuse University, Syracuse, NY (US); The Research Foundation for the State University of New York, University at Buffalo, Amherst, NY (US)

(72) Inventors: Viktor Cybulskis, North Syracuse, NY (US); Eleni Kyriakidou, Buffalo, NY (US); Tala Mon, Buffalo, NY (US); Jingzhi Liu, Syracuse, NY (US)

(73) Assignees: Syracuse University, Syracuse, NY (US); The Research Foundation for the State University of New York, University at Buffalo, Amherst, NY (US)

(21) Appl. No.: 19/112,078

(22) PCT Filed: Sep. 14, 2023
(86) PCT No.: PCT/US2023/032724

§ 371 Date: Mar. 14, 2025

Related U.S. Application Data
(60) Provisional application No. 63/406,832, filed on Sep. 15, 2022.

(51) Int. Cl. B01J 29/74; B01D 53/94; B01J 35/64; B01J 37/06; B01J 37/12; B01J 37/30

(52) U.S. Cl. CPC B01J 29/743; B01D 53/94; B01J 35/643; B01J 37/06; B01J 37/12; B01J 37/30; B01D 2255/50; B01D 2258/01

(57) ABSTRACT

High silica (silicon/aluminum molar ratios >30), small pore (~0.36-0.45 nm pore apertures) zeolite catalysts for CH₄ remediation in low temperature (<400° C.), high water vapor environments (5-10%), such as those associated with natural gas vehicle exhaust streams. The catalysts can achieve T₉₀'s below 400° C. and remain hydrothermally stable over extended periods of time. The zeolite catalyst may be made by a molar gel composition of the appropriate reagents that is heated in a reaction vessel and then subjected to ion exchange with a source of palladium to achieve less than 2 weight percent loading of palladium in the zeolite.

### STATEMENT REGARDING FEDERALLY SPONSORED RESEARCH OR DEVELOPMENT

This invention was made with government support under Grant No. DE-AC36-08GO28308 awarded by the Department of Energy. The government has certain rights in the invention.

### BACKGROUND OF THE INVENTION

### 1. Field of the Invention

The present invention relates to catalysts for methane (CH₄) remediation and, more specifically, to Pd-based, high silica, small pore zeolite catalysts with improved CH₄ combustion performance at low temperature under lean-burn conditions and in high water vapor environments.

### 2. Description of the Related Art

Natural gas has garnered attention as a cleaner alternative fuel for vehicles compared to gasoline or diesel. The exhaust of natural gas vehicles (NGVs), however, contains methane (CH₄) which is 25 times more harmful than carbon dioxide (CO₂) in global warming potential. The conventional solution for CH₄ remediation is its catalytic oxidation by using Pd/Al₂O₃ and Pd/ZrO₂ catalysts. As the NGV exhaust feed is at a low temperature (<400° C.) and contains high amounts of steam (5-10%), the catalytic oxidation of CH₄ by Pd/Al₂O₃ and Pd/ZrO₂ catalysts suffers from low conversions and deactivation through Pd sintering. In addition, Pd is susceptible to sintering and hydroxyl accumulation on active PdO sites in the presence of H₂O that can lower CH₄ conversion and reduce catalyst life. As a result, there is a need in the art for a catalyst that can operate in the low temperature and high water vapor environment of NGV exhaust to provide for improved CH₄ remediation.

### BRIEF SUMMARY OF THE INVENTION

The present invention provides an approach for making Pd-based, high silica (Si/Al molar ratios ≥50) small pore zeolite catalysts that have increased durability and improved low temperature CH₄ oxidation performance (≥90% CH₄ conversion at temperatures <400° C.). The zeolite catalyst may be made by forming a zeolite having a silica to aluminum ratio greater than 30 and a pore size of less than 0.5 nm in a reaction vessel, wherein the zeolite has a Chabazite (CHA) topology or a Linde Type A (LTA) topology and then performing ion exchange with a source of palladium to achieve less than 2 weight percent loading of palladium in the zeolite.

In one aspect, the step of forming a zeolite may comprise positioning a molar gel composition of an amount of water, an amount of sodium hydroxide, an amount of an organic structure directing agent, an amount of aluminum oxide, and an amount of silicon dioxide in the reaction vessel. The step of forming a zeolite may further comprise aging the molar gel composition for a predetermined time period at room temperature. The step of forming a zeolite may further comprise heating the molar gel composition at 160° C. for a second predetermined time period after aging. The step of forming a zeolite may further comprise separating the zeolite from a supernatant by centrifugation after heating the molar gel composition. The step of forming a zeolite may further comprise washing the zeolite and then drying the zeolite after separating the zeolite. The step of forming a zeolite may further comprise calcining the zeolite in a muffle furnace.

In another aspect, the step of forming a zeolite comprises synthesizing an organic structure directing agent by adding an amount of dimethyl imidazole and an amount of methylbenzyl chloride to an amount of toluene and refluxing at 100° C. for a first predetermined time period under an argon atmosphere. The step of forming a zeolite may further comprise separating the organic structure directing agent from any solution, converting the organic structure directing agent to a hydroxide form. The step of forming a zeolite may further comprise positioning a molar gel composition of an amount of water, an amount of sodium hydroxide, an amount of the organic structure directing agent, an amount of tetramethylammonium hydroxide, an amount of hydrofluoric acid, an amount of aluminum oxide, and an amount of silicon dioxide in the reaction vessel. The step of forming a zeolite may further comprise heating the molar gel composition to 160° C. for a predetermined amount of time while rotating the molar gel composition. The step of forming a zeolite may further comprise separating the zeolite from a supernatant by centrifugation after heating the molar gel composition. The step of forming a zeolite may further comprise washing the zeolite and then drying the zeolite after separating the zeolite.

In a further aspect, the present invention includes a zeolite formed according to various methods described herein.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of a microreactor for CH₄ temperature programmed oxidation and stability testing of Pd-based, high silica (Si/Al≥50) small pore zeolite catalysts made according to the present invention.

FIG. 2 is a graph of the T_{50, 90} temperatures for CH₄ conversion, corresponding to the temperatures where 50% and 90% of CH₄ is converted, respectively, under simplified lean conditions over 1 wt. % Pd/Al₂O₃ and 1 wt. % Pd/CHA (Si/Al=15, 33, 53, 137).

FIG. 3 is a graph of the T_{50, 90} temperatures for CH₄ conversion under simplified lean conditions over 1 wt. % Pd/Al₂O₃ and 1 wt. % Pd/H-LTA (Si/Al=1, 22, 31, 39, 52).

FIG. 4 is a graph of catalyst stability for CH₄ conversion at 450° C. under the simplified lean conditions over Pd/Al₂O₃ and Pd/H-LTA (Si/Al=52) for 10 h.

FIG. 5 is a graph of T_{50,90} comparison of 2 wt. % Pd/CHA (Si/Al=156) washcoated mini-core under realistic rich, moderate lean, and lean conditions as fresh, after hydrothermal aging (HTA) at 650° C. for 12 h in 10% H₂O and 20% O₂ in Ar, and after 20 ppm SO₂ poisoning at 300° C. for 5 h.

### DETAILED DESCRIPTION OF THE INVENTION

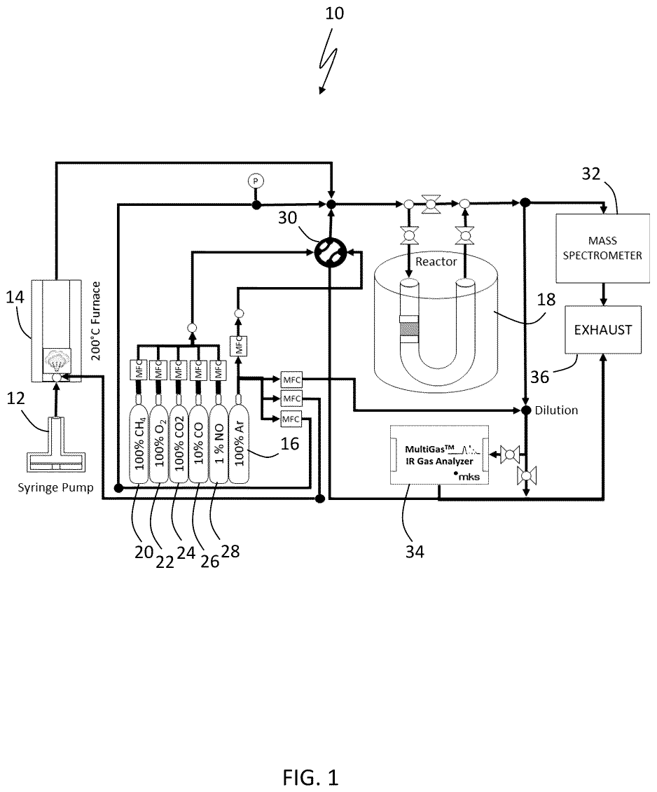

Referring to the figures, wherein like numeral refer to like parts throughout, the present invention involves the hydrothermal synthesis of high silica (silicon/aluminum molar ratios >30), small pore (~0.3-0.5 nm pore apertures) zeolites and the use of such zeolites for methane oxidation, such as in NGV exhaust streams. The synthesis employs sodium hydroxide (OH) media (Example 1) and hydrofluoric acid (HF) media (Example 2) that include, but are not limited to, zeolites with Chabazite (CHA) and Linde Type A (LTA) frameworks. After synthesis, Pd is added to the zeolite powder by either ion-exchange or wet-impregnation, up a loading of 1 wt. %, (Example 3) and is evaluated for its CH₄ oxidation performance in a microreactor (FIG. 1, Example 4). All zeolite catalysts are named with Si/Al molar ratio in parentheses.

Referring to FIG. 1, a system 10 for the evaluation of high silica (silicon/aluminum molar ratios >30), small pore (~0.3-0.5 nm pore apertures) zeolites may include a syringe pump 12 for delivering reactants to a furnace 14. Furnace 14 includes an inlet coupled to a source of argon 16. Furnace 14 includes an outlet coupled to an inlet of a reactor 18. Reactor 18 is further coupled to a source of methane 20, a source of oxygen 22, a source of carbon dioxide 24, a source of carbon monoxide 26, a source of nitric oxide 28, and the source of argon 16. The source of methane 20, source of oxygen 22, source of carbon dioxide 24, source of carbon monoxide 26, source of nitric oxide 28, and source of argon 16 may be premixed together with a premixer 30 and also with the outlet of furnace 14 prior to reactor 18. Reactor 18 includes an outlet coupled to a mass spectrometer 32 and also to a gas analyzer 34. Source of argon 16 may be used to provide dilution to the reactor outlet components provided by gas analyzer 34. Mass spectrometer 32, premixer 30, and gas analyzer may be coupled to an exhaust 36.

### Example 1—Synthesis of High Silica CHA Zeolite

Synthesis of high silica CHA zeolites requires water (H₂O), a hydroxide source, an organic structure directing agent (OSDA), an alumina (Al₂O₃) source, and a silica (SiO₂) source. The source for water is ASTM Type I ultra-pure water, hydroxide used is sodium hydroxide (NaOH) pellets from Macron Fine Chemicals (ACS grade), OSDA is N,N,N-trimethyl-1-adamantantylammonium hydroxide (TMAda-OH) (25.3%) from Sachem Zeogen, Al₂O₃ is aluminum hydroxide (Al(OH)₃) from Sigma-Aldrich, and SiO₂ is fumed silica (0.007 μm) from Sigma-Aldrich. Molar gel composition of 2200H₂O:10NaOH:10TMAda-OH:xAl₂O₃:100SiO₂ where x is ≤1 (Si/Al≥50) is mixed into a PTFE liner that is inserted into a stainless steel autoclave reactor vessel. The synthesis gel is allowed to age for 2 h at room temperature before heating the reactor vessel in a rotary convection oven (60 rpm) at 160° C. for 24 h. The CHA zeolite was separated from the supernatant by centrifugation (4500 rpm, 5 min), and then washed with acetone and ASTM Type I water in alternating wash/centrifuge/decant cycles (2 washes with each solvent, ~15 ml solvent per wash). The solids were dried in air at 100° C. for 24 h, and then calcined in a muffle furnace at 580° C. in 100 cm³min⁻¹(g_{zeolite})⁻¹ dry air with a 1° C. min⁻¹ ramp for 8 h and a 3 h isothermal step at 150° C.

### Example 2—Synthesis of High Silica LTA Zeolite

Synthesis of high silica LTA zeolites requires H₂O (ASTM Type I ultra-pure water), HF (48%, Sigma Aldrich), Al₂O₃(Al(OH)₃, Sigma-Aldrich), SiO₂ (tetraethoxysilane, STREM Chemicals), tetramethylammonium hydroxide (TMAOH·5H₂O) (97%, Sigma-Aldrich) and pre-synthesized OSDA-OH. The OSDA-OH was synthesized by adding 11.60 g 1,2-dimethyl imidazole and 15.46 g 4-methylbenzyl chloride to 125 ml toluene and refluxing the reaction mixture at 100° C. for 24 h under Ar atmosphere. The formed material was separated from the mother solution via centrifugation and washed 3 times with 50 ml ethyl acetate followed by drying at 110° C. overnight. The as-synthesized OSDA(Cl) was converted to its hydroxide form (OSDA(OH)) by adding the OSDA(Cl) solution to hydroxide exchange resin until a full exchange was determined by titrating the OSDA(OH) solution with 0.01 M HCl. The obtained OSDA(OH) solution was then concentrated by rotary evaporation at 80° C. to 20-25%. Molar gel composition of 500H₂O:45OSDA-OH:5TMAOH·5H₂O:5HF:xAl₂O₃:100SiO₂ where x is ≤1 (Si/Al≥50) is mixed into a PTFE liner that is inserted into a stainless steel autoclave reactor vessel. The vessel is heated to 160° C. for at least 4 days at 60 rpm in a rotary convection oven. LTA zeolites were separated from the supernatant by centrifugation (4500 rpm, 5 min), and then washed with acetone and ASTM Type I water in alternating wash/centrifuge/decant cycles (2 washes with each solvent, ~15 ml solvent per wash). The solids were dried in air at 100° C. for 24 h, and then calcined in a muffle furnace at 580° C. in 100 cm³min⁻¹ (g zeolite)⁻¹ dry air with a 1° C. min⁻¹ ramp for 8 h and a 3 h isothermal step at 150° C.

### Example 3—Preparation of Pd-Based Zeolite Catalysts

Pd ion-exchange of small pore zeolites was performed using Pd(NO₃)₂ (Sigma-Aldrich) solution at 80° C. for 24 h to achieve 1-2 wt. % Pd loading. The zeolite catalysts were calcined at 500° C. for 2 h. Calcined catalysts were pressed and sieved to 250-500 μm pellets.

### Example 4—Preparation of Washcoated Pd-Based Zeolite Mini-Cores

The slurry composition for washcoating cordierite mini-cores (0.5″ D×1″ H) with cell per square inch of 400 and wall thickness of 3 mil (1/1000 inch) contained 20 wt. % solid phase and 80 wt. % liquid phase. The solid phase contained 95-100 wt. % catalyst and 0-5 wt. % P2 Boehmite binder (Sasol). The slurry pH was adjusted between 3-6 using 1 M NH₄NO₃ solution with target washcoat loading was 1 g_{washcoat} in⁻³. The washcoated monoliths were dried at 110° C. (3° C. min⁻¹) for 1 h and calcined at 550° C. (3° C. min⁻¹) for 2 h.

### Example 5—Evaluation

Evaluation of Pd-based zeolite catalysts and washcoated mini-cores in microreactor CH₄ temperature programmed oxidation experiments over as-synthesized catalysts and washcoated mini-cores were performed in a packed bed reactor, as seen in FIG. 1. The reactor quartz tube was loaded with 100 mg of catalyst pellets, the total flow was maintained to 333 cm³min⁻¹ (STP), while the weigh-hourly space velocity (WHSV) was kept at 199.8 1 g_{cat}⁻¹h⁻¹. The catalysts were pretreated in 5% O₂ in Ar at 500° C. (10° C. min⁻¹) for 20 min and cooled down to 200° C. Further pretreatment was performed using simplified lean conditions (1500 ppm CH₄, 5% O₂, 5% H₂O) by heating the catalysts to 650° C. (5° C. min⁻¹) for 1 h and cooled down to 200° C. For the evaluation of the catalytic performance, the catalysts were heated to 650° C. (5° C. min⁻¹) under the CH₄ oxidation feed. Temperature for 50% and 90% CH₄ conversions (T_{50,90}, respectively) were determined based on the resulting light-off curves. Stability testing was performed after the pretreatment by holding the catalysts at 450° C. for 10 h. The washcoated mini-cores were evaluated with a flow rate of 163 cm³min⁻¹ (STP), and gas-hourly hour space velocity (GHSV) of 22,534 h⁻¹. The mini-cores were pretreated in 20% O₂ in Ar at 500° C. for 2 h before each sequential ramp up to 600° C. in the realistic rich, moderate lean, and lean conditions, as set forth in Table 1 below: Table 1—Emissions from a CNG powered engine under realistic rich, moderate lean, and lean conditions.

| Gas Concentrations | Rich | Moderate Lean | Lean |
|---|---|---|---|
| CH₄ (ppm) | 2286 | 1490 | 2637 |
| O₂ (%) | 0.62 | 3.97 | 8.38 |
| H₂O (%) | 10 | 10 | 10 |
| CO₂ (%) | 8.84 | 7.69 | 5.65 |
| CO (ppm) | 6404 | 692 | 752 |
| NO (ppm) | 1698 | 1864 | 94 |

Hydrothermal aging (HTA) on the washcoated mini-cores was performed at 650° C. for 12 h in 10% H₂O and 20% O₂/Ar followed by evaluation under rich, moderate lean, and lean conditions. After HTA, the mini-core was also subjected to 20 ppm of SO₂ poisoning in Ar at 300° C. for 5 h followed by evaluation under rich, moderate lean, and lean conditions.

### Results

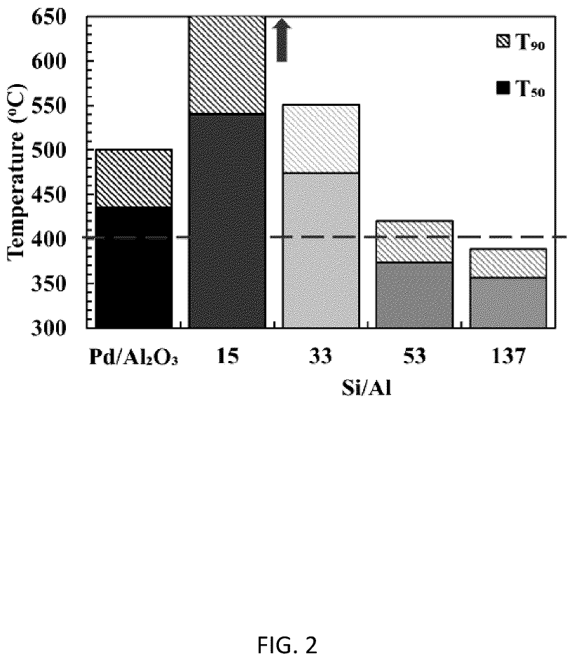

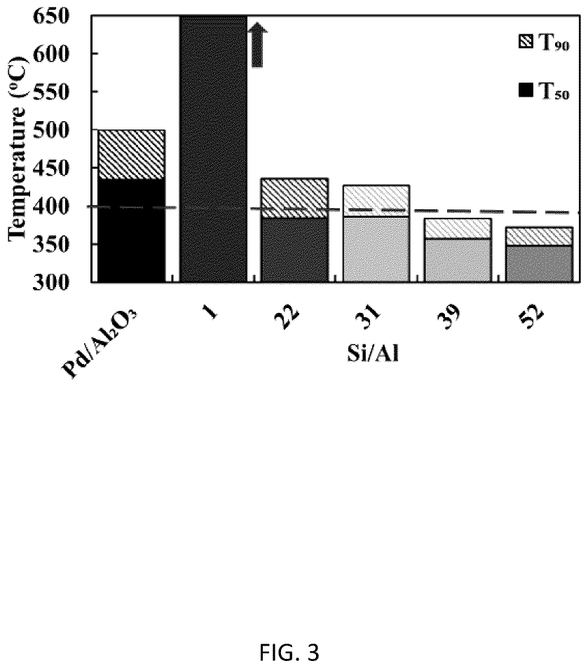

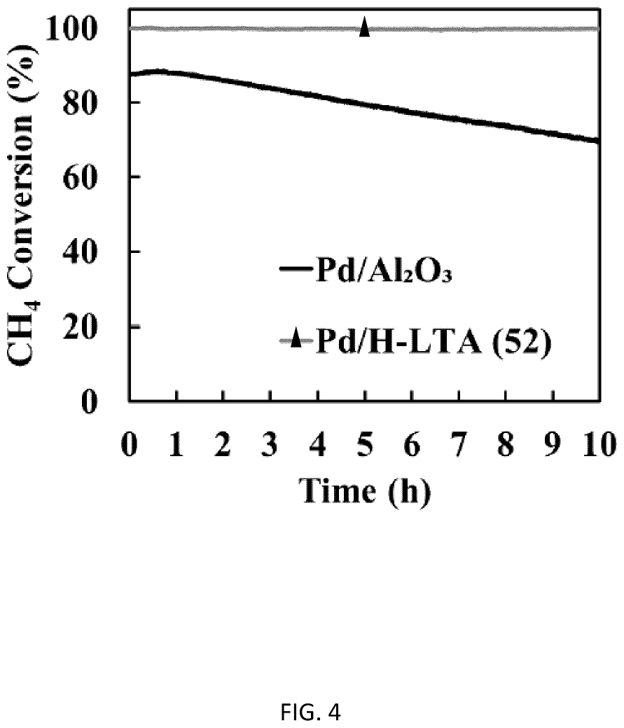

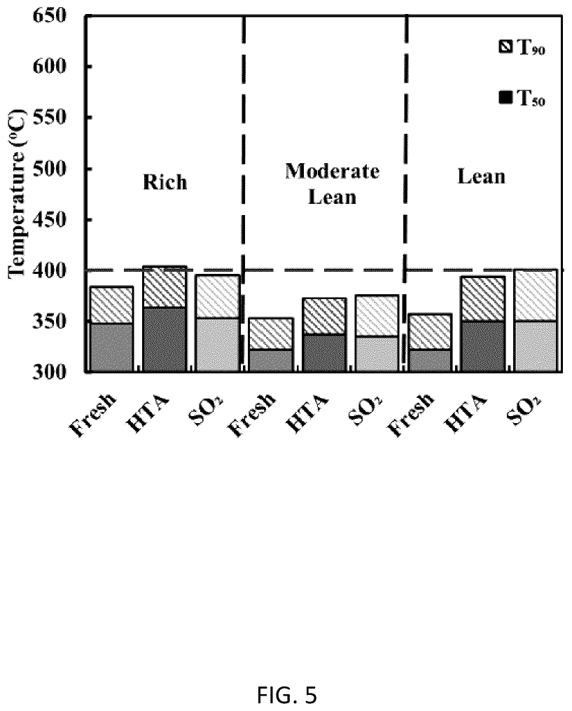

For Pd/CHA zeolite catalysts, Si/Al molar ratios >53 are required to achieve 90% CH₄ conversion temperature (T₉₀)<400° C., as seen in FIG. 2. Specifically, Pd/CHA (Si/Al=137) was able to obtain T₉₀ of 389° C. For Pd/H-LTA zeolite catalysts, Si/Al molar ratios >31 are required to achieve T₉₀<400° C., as seen in FIG. 3. Specifically, Pd/H-LTA (Si/Al=39) and Pd/H-LTA (Si/Al=52) were able to obtain T₉₀'s of 384° C. and 372° C., respectively. As Si/Al molar ratios increased for both Pd/CHA and Pd/H-LTA zeolite catalysts, the T₉₀'s decreased. 100% CH₄ conversion at 450° C. was maintained for Pd/H-LTA (Si/Al=52) compared to 70% conversion over conventional Pd/Al₂O₃ over a 10 h time period in 5% H₂O, as seen in FIG. 4, highlighting the hydrothermal stability of high silica Pd/H-LTA zeolite catalysts. Further increasing the Si/Al of Pd/CHA to 156 and washcoating on mini-cores shows resistance to HTA and SO₂ poisoning with T₉₀ close to 400° C. or below, as seen in FIG. 5.

What is claimed is:

1. A method of forming a high silica, small pore zeolite catalyst, comprising the steps of:
forming a zeolite having a silica to aluminum ratio greater than 30 and a pore size of less than 0.5 nm in a reaction vessel, wherein the zeolite has a Chabazite (CHA) topology or a Linde Type A (LTA) topology; and
performing ion exchange with a source of palladium to achieve less that 2 weight percent loading of palladium in the zeolite.

2. The method of claim 1, wherein the step of forming a zeolite comprises positioning a molar gel composition of an amount of water, an amount of sodium hydroxide, an amount of an organic structure directing agent, an amount of aluminum oxide, and an amount of silicon dioxide in the reaction vessel.

3. The method of claim 2, wherein the step of forming a zeolite further comprises aging the molar gel composition for a predetermined time period at room temperature.

4. The method of claim 3, wherein the step of forming a zeolite further comprises heating the molar gel composition at 160° C. for a second predetermined time period after aging.

5. The method of claim 4, further comprising separating the zeolite from a supernatant by centrifugation after heating the molar gel composition.

6. The method of claim 5, further comprising washing the zeolite and then drying the zeolite after separating the zeolite.

7. The method of claim 5, further comprising calcining the zeolite in a muffle furnace.

8. The method of claim 1, wherein the step of forming a zeolite comprises synthesizing an organic structure directing agent by adding an amount of dimethyl imidazole and an amount of methylbenzyl chloride to an amount of toluene and refluxing at 100° C. for a first predetermined time period under an argon atmosphere.

9. The method of claim 8, wherein the step of forming a zeolite further comprises separating the organic structure directing agent from any solution, converting the organic structure directing agent to a hydroxide form.

10. The method of claim 9, wherein the step of forming a zeolite further comprises positioning a molar gel composition of an amount of water, an amount of sodium hydroxide, an amount of the organic structure directing agent, an amount of tetramethylammonium hydroxide, an amount of hydrofluoric acid, an amount of aluminum oxide, and an amount of silicon dioxide in the reaction vessel.

11. The method of claim 10, wherein the step of forming a zeolite further comprises heating the molar gel composition to 160° C. for a predetermined amount of time while rotating the molar gel composition.

12. The method of claim 11, further comprising separating the zeolite from a supernatant by centrifugation after heating the molar gel composition.

13. The method of claim 12, further comprising washing the zeolite and then drying the zeolite after separating the zeolite.

14. A catalyst comprising a zeolite having a silica to aluminum ratio greater than 30 and a pore size of less than 0.5 nanometers, wherein the zeolite has a Chabazite (CHA) topology or a Linde Type A (LTA) topology and wherein the zeolite includes up to two percent by weight, inclusively, of palladium.

15. An engine exhaust aftertreatment system, comprising a catalytic convertor including a zeolite having a silica to aluminum ratio greater than 30 and a pore size of less than 0.5 nanometers, wherein the zeolite has a Chabazite (CHA) topology or a Linde Type A (LTA) topology and wherein the zeolite includes between up to two percent by weight, inclusively, of palladium.
